(19) United States
(12) Patent Application Publication
(10) Pub. No.: US 2024/0180121 A1
(43) Pub. Date: Jun. 6, 2024

(54) PET BEDS AND COMPONENTS THEREOF

(71) Applicant: Worldwise, Inc., Novato, CA (US)

(72) Inventors: Brooke Rogers, San Rafael, CA (US); Lyle Koenig, San Francisco, CA (US); Ingrid VonderWische, Lombard, IL (US); Sarah Frank, Novato, CA (US)

(21) Appl. No.: 18/074,115

(22) Filed: Dec. 2, 2022

(51) Int. Cl. A01K 1/035; A47C 31/02

(52) U.S. Cl. CPC A01K 1/0353; A47C 31/026

(57) ABSTRACT

A pet bed includes a cover and a liner disposed within the cover. The liner can have one or more liner members that are connected to each other, where the interiors of the liner members are not in communication with each other. The cover can include one or more tuft strips that are movable between a connected configuration and a disconnected configuration.

### TECHNICAL FIELD

The present invention relates generally to pet beds and, more specifically, to liners and covers for pet beds.

### BACKGROUND

There are many pet beds available to consumers having a variety of sizes and shapes. Pet beds typically include stuffing or filling that is packed within a liner and/or cover such that adequate support is provided that allows for the pet (e.g., dogs, cats, etc.) to lounge or sleep. Oftentimes, pets develop a strong affinity for their beds and seek them out as a safe haven for promoting rest and relaxation.

### SUMMARY

An example of a liner for a pet bed includes a first liner member and a second liner member. The first liner member has a first opening and a first interior area, where the first opening is movable between open and closed configurations. The second liner member has a second opening and a second interior area, where the second opening is movable between open and closed configurations. The second liner member is connected to the first liner member such that the first and second interior areas are not in communication with each other.

An example of a cover for a pet bed includes a top cover portion, a bottom cover portion that is connected to the top cover portion, and one or more tuft strips connected to the top and bottom cover portions. Each of the tuft strips include an upper tuft strip member and a lower tuft strip member. The upper tuft strip member has an upper extension member and an upper connection member, and the lower tuft strip member has a lower extension member and a lower connection member. The upper connection member and the lower connection member are configured to be releasably connected in an interior of the cover such that the tuft strip is movable between a connected configuration and a disconnected configuration.

An example of a pet bed includes a cover and a liner. The cover has a top portion and a bottom portion that at least partially define a bed interior. The cover further includes a plurality of tuft strips, where each tuft strip has an upper tuft strip member that is connected to the top portion of the cover and a lower tuft strip member that is connected to a bottom portion of the cover. The upper tuft strip member and the lower tuft strip member are configured to be releasably connected such that the tuft strip is movable between a connected configuration and a disconnected configuration. The liner is configured to be disposed in the bed interior of the cover. The liner has a first outer liner member, a second outer liner member, and a middle liner member. The first outer liner member has a first opening and a first interior area, where the first opening is movable between open and closed configuration. The second outer liner member has a second opening and a second interior area, where the second opening is movable between open and closed configuration. The middle liner member has a third opening and a third interior area, where the third opening is movable between open and closed configuration. The first outer liner member is connected to the middle liner member such that one or more first elongated openings are disposed between the first outer liner member and the middle liner member. The second outer liner member is connected to the middle liner member such that one or more second elongated openings are disposed between the second outer liner member and the middle liner member. At least one first tuft strip of the plurality of tuft strips of the cover is positioned in at least one first elongated opening of the one or more first elongated openings when the at least one tuft strip is in a connected configuration, and at least one second tuft strip of the plurality of tuft strips of the cover is positioned in at least one second elongated opening of the one or more second elongated openings when the at least one tuft strip is in a connected configuration.

### BRIEF DESCRIPTION OF THE DRAWINGS

FIG. 1 is a schematic view of an exemplary liner for a pet bed;

FIG. 2 is a schematic view of an exemplary pet bed that includes the liner of FIG. 1;

FIG. 3 is a schematic view of an exemplary liner for a pet bed;

FIG. 4 is a schematic view of an exemplary connection between a first liner member and a second liner member of the pet bed of FIG. 3;

FIG. 5 is a schematic view of another exemplary connection between a first liner member and a second liner member of the pet bed of FIG. 3;

FIG. 6 is a schematic view of another exemplary connection between a first liner member and a second liner member of the pet bed of FIG. 3;

FIG. 7 is a schematic view of another exemplary connection between a first liner member and a second liner member of the pet bed of FIG. 3;

FIG. 8 is a schematic view of an exemplary liner for a pet bed;

FIG. 9 is a perspective view of an exemplary liner for a pet bed;

FIG. 10 is a top view of the liner of FIG. 9;

FIG. 11 is a bottom view of the liner of FIG. 9;

FIG. 12 is a front view of the liner of FIG. 9;

FIG. 13 is a rear view of the liner of FIG. 9;

FIG. 14 is a top view of an exemplary pet bed that includes the liner of FIG. 9;

FIG. 15 is a top schematic view of an example cover 512 for a pet bed;

FIG. 16 is a cross-sectional schematic view of the cover of FIG. 15 taken along the line 16-16 shown in FIG. 15;

FIG. 17 is a cross-sectional schematic view of the cover of FIG. 15 taken along the line 17-17 shown in FIG. 15;

FIG. 18 illustrates an example tuft strip of a cover for a pet bed;

FIG. 19 illustrates an example tuft strip of a cover for a pet bed; and

FIG. 20 illustrates a top schematic view of an example pet bed that includes the cover of FIG. 15 and liner of FIG. 9.

### DETAILED DESCRIPTION

The Detailed Description describes exemplary embodiments of the invention and is not intended to limit the scope of the claims in any way. Indeed, the invention is broader than and unlimited by the exemplary embodiments, and the terms used in the claims have their full ordinary meaning. Features and components of one exemplary embodiment may be incorporated into the other exemplary embodiments. Inventions within the scope of this application may include additional features, or may have less features, than those shown in, and described in connection with, the exemplary embodiments.

As described herein, the terms “substantially” and “about” are defined as at least close to (and includes) a given value or state (preferably within 10% of, more preferably within 1% of, and most preferably within 0.1% of a given value or state).

Some of the pet beds described herein include a liner having a shape that allows a user to easily place a cover over the liner. Some of the pet bets described herein have one or more connected liner members having interior areas that are not in communication with each other, which prevents the pet beds from becoming uneven due to filling being moved to various interior areas of the pet bed as a result of pets sleeping or lounging in a single location on the pet bed. Some of the pet beds described herein include a cover having one or more tuft strips that are movable between connected and disconnected configurations, which allow for a user to more easily move interior pet bed components (e.g., a liner) within the interior of the cover.

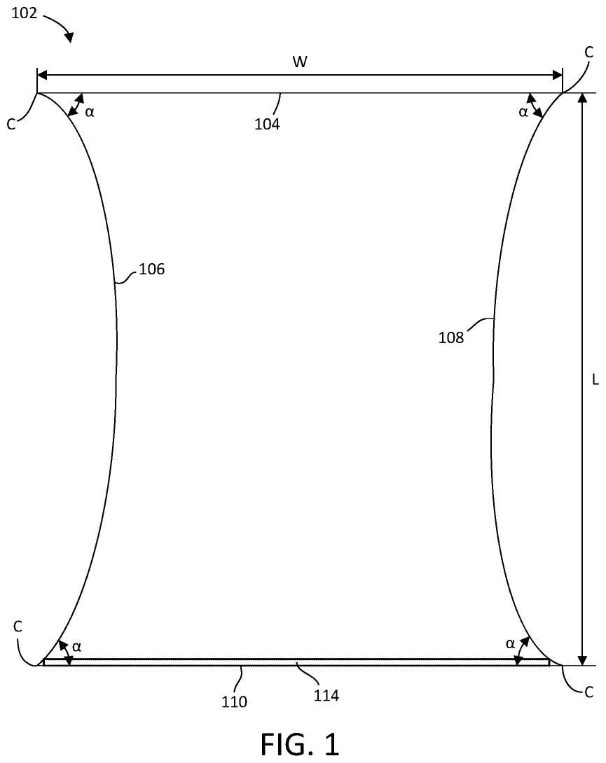

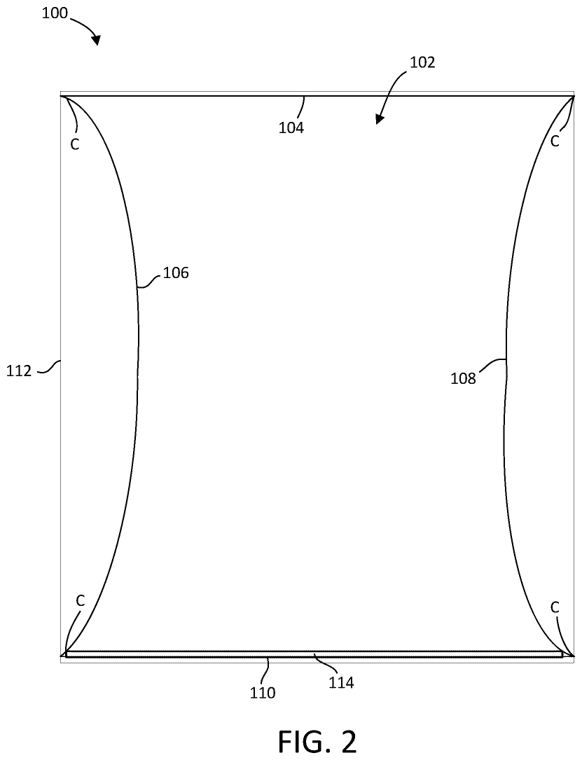

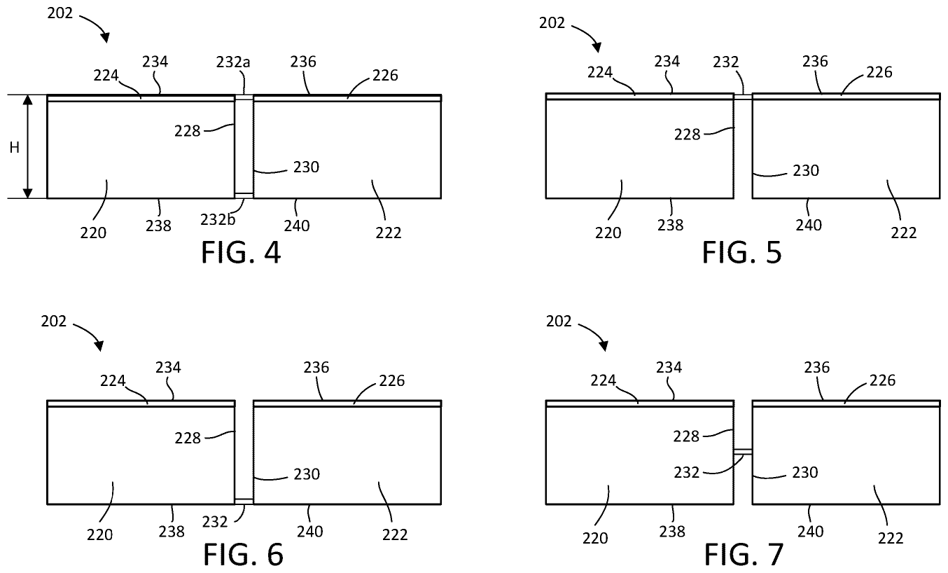

FIGS. 1-2 illustrate an example of a liner 102 for a pet bed 100 (FIG. 2). The liner 102 has a top edge 104, a first side edge 106, a second side edge 108, and a bottom edge 110. The first and second side edges 106, 108 are shaped such that a user can more easily place a cover 112 (FIG. 2) onto the liner. For example, the sides edges 106, 108 can have a shape in which the width W is variable along a length L of the liner 102. As shown in the illustrated example, the side edges 106, 108 can be trumpeted or curved. However, the side edges 106, 108 can take any other suitable form in which the width decreases from at least one of the top or bottom edge 104, 110 toward a central portion of the liner 102. In certain instances, an angle α at the corners C of the liner 102 can be between about 15 degrees and about 89 degrees, such as between about 45 degrees and about 89 degrees, such as between about 60 degrees and about 89 degrees, such as between about 75 degrees and about 89 degrees, such as between about 80 degrees and 89 degrees, such as about 86 degrees. The angle α at the corners of the liner 102 can be identical at each corner, or the angles can be different at one or more of the corners. The liner 102 can have a height (not shown—similar to the height H shown for the liner 202 shown in FIG. 4) that is between about 1 inch and about 20 inches, such as between about 1 inch and about 10 inches, such as between about 3 inches and about 8 inches, such as between about 6 inches and about 7 inches, such as about 6.7 inches. While the illustrated example of the liner 102 is shown as having a shape having four edges (i.e., the top edge 104, the first and second side edges 106, 108, and the bottom edge 110), it should be understood that the liner 102 can have any suitable shape in which the width W of the liner decreases along a portion of a length L of the liner 102 between the top and bottom portions of the liner 102.

Referring to FIG. 2, a cover 112 can be placed over an exterior of the liner 102 such that the cover 112 extends entirely or at least partially over the top edge 104, the first and second side edges 106, 108, and the bottom edge 110 of the liner 102. The shape of the liner 102 allows for the cover 112 to be easily placed over the liner 102. That is, the shape of the liner 102 causes the liner 102 to have less surface area for the cover 112 to be extended over as compared a typical square or rectangular shaped liner. The shape of the liner 102 is configured to ensure that filling material (e.g., fiberfill, foam, etc.) is disposed inside the liner 102 such that the corners C of the liner 102 extend fully to each corner of the cover 112, which allows pet bed to maintain a substantially uniform height along both the length L and width W of the liner 102 and cover 112. That is, the curved or trumpeted shape of the liner 102 causes the filling material to extend to and maintain a position in the corners C of the liner 102 and, consequently, in the corners of the cover 112 such that the height in the corners of both the liner 102 and cover 112 are substantially equal to the height of the remaining portions of the liner 102 and cover 112.

The liner 102 can include an opening 114 that allows a user to access an interior of the liner 102, where the opening 114 is movable between open and closed configurations. For example, the liner 102 can include a fastener (e.g., a zip fastener, button(s), etc.) that allows for a user to move the opening 114 between the open and closed configurations. The opening allows for filling material (e.g., fiberfill, foam, etc.) to be placed into the interior of the liner such that the liner provides cushioning for a pet that is using the pet bed 100, as well as allowing for a user to move or replace filling that is disposed within the liner 102. The liner 102 can be made of, for example, a non-woven material (e.g., polypropylene) or a woven material (e.g., taffeta).

The cover 112 can have an opening (not shown) that is movable between open and closed positions, where the user is able to place the liner 102 into the cover 112 or remove the liner 102 from the cover 112 when the opening is in the open position. In other instances, a bottom portion of the cover 112 is open such that the cover can be extended over the liner 102. The cover 112 can be made of, for example, polyester, cotton, rayon, or any other suitable material.

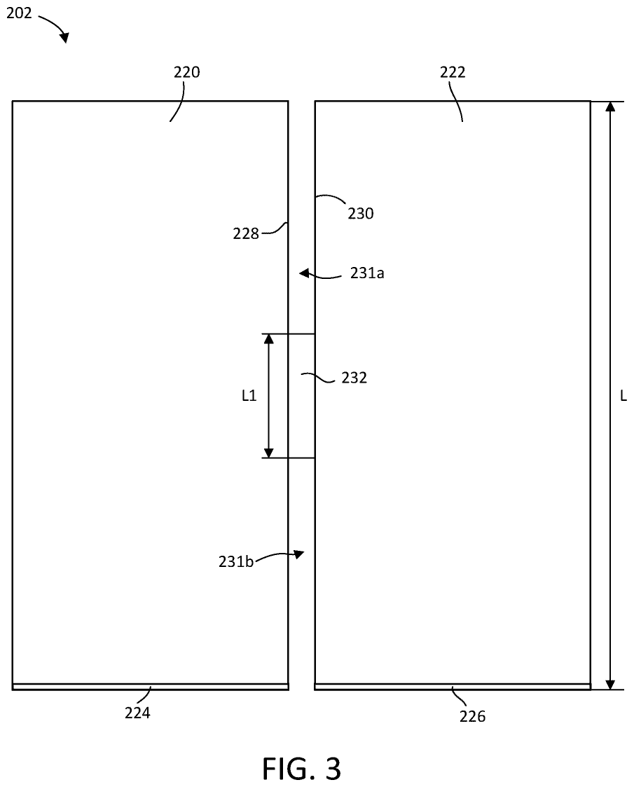

FIG. 3 illustrates an example of a liner 202 for a pet bed. The liner 202 includes a first liner member 220 and a second liner member 222 that is connected to the first liner member 220. The first and second liner members 220, 222 can be made of, for example, a non-woven material (e.g., polypropylene) or a woven material (e.g., taffeta). The pet bed can include a cover (not shown) that extends over the liner 202. The cover can take any suitable form, such as, for example, any form described in the present application.

The first liner member 220 has an opening 224 that allows a user to access an interior of the first liner member 220, where the opening 224 is movable between open and closed configurations. The second liner member 222 has an opening 226 that allows a user to access an interior of the second liner member 222, where the opening 226 is movable between open and closed configurations. The first and second liner members 220, 222 can each include a fastener (e.g., a zip fastener, button(s), etc.) that allows for a user to move the respective openings 224, 226 between the open and closed configurations. The openings 224, 226 allow for filling material (e.g., fiberfill, foam, etc.) to be placed into the interior of each of the first and second liner members 220, 222 such that the liner 202 provides cushioning for a pet that is using the pet bed, as well as allowing for a user to move or replace filling that is disposed within each of the first and second liner members 220, 222.

The interiors of the first and second liner members 220, 222 are not in communication with each other. That is, interiors of the first and second liner members 220, 222 are separated from each other such that a user can only access the interior of the first liner member 220 via the opening 224, and such that the user can only access the interior of the second liner member 222 via the opening 226. This is advantageous because filling is prevented from moving from the first liner member 220 to the second liner member 222, and vice versa, when a pet is using the pet bed, which prevents the pet bed from becoming uneven due to more filling being disposed on one side of the pet bed versus the other side of the pet bed. That is, with typical pet beds, a pet may be situated on one side of the pet bed which causes the filling on that side of the pet bed to move to the other side of the pet bed such that the pet bed is uneven. In these situations, the pet bed may remain uneven when the pet is no longer using the pet bed. However, referring to the example liner 202 shown in FIG. 3, the two separate liner members 220, 222 having interiors that are not in communication with each other prevents filling from moving to the other side of the pet bed, which prevents the pet bed from becoming uneven.

The first and second liner members 220, 222 can be connected in a variety of ways. For example, one or more connection members 232 can be connected to each of the liner members 220, 222. The connection member can include, for example, a piece of cloth, a strap and buttoned member, a hook and loop member, a zippered member, a snap-type member, and/or any other suitable component that is capable of connecting the first and second liner members 220, 222 to each other. In other examples, the first and second liner members can be directly connected to each other. The first liner member 220, the second liner member 222, and/or the connection member 232 can be connected by any suitable means, such as, for example, by sewing, an adhesive, a hook and loop connection, a buttoned connection, or any other suitable type of connection. The first and second liners 220, 222 can be fixedly connected (e.g., via sewing, adhesive, etc.) or removably connected (e.g., via a hook and loop connection, a buttoned connection, a zippered connection, a snap-type connection, etc.).

In the illustrated example, an inner side edge 228 of the first liner member 220 is connected to an inner side edge 230 of the second liner member 222 by one or more connection members 232. Referring to FIG. 4, the first liner member 220 is connected to the second liner member 222 by two connection members 232a, 232b. In this example, the first connection member 232a connects upper edges 234, 236 of the first and second liner members 220, 222 together, and the second connection member 232b connects lower edges 238, 240 of the first and second liner members 220, 222 together. Referring to FIG. 5, only the upper edges 234, 236 of the first and second liner members 220, 222 are connected by the connection member 232. Referring to FIG. 6, only the lower edges 238, 240 are connected by the connection member 232. Referring to FIG. 7, a center of the inner side edge 228 of the first liner member 220 is connected to a center of the inner side edge 230 of the second liner member 222 by the connection member 232.

While FIG. 7 shows the first and second liner members 220, 222 being connected at the center of the respective inner side edges 228, 230, it should be understood that the inner side edges 228, 230 can be connected at any other position between the upper edges 234, 236 and lower edges 238, 240 of the first and second liner members 220, 222. While FIGS. 4-7 show the first and second liner members 220, 222 being connected by one or more connection members, it should be understood that the first and second liner members 220, 222 can be directly connected at the same locations shown and described with reference to FIGS. 4-7. The illustrated examples show the liner 202 having one or two connection members 232 for connecting the first and second liner members 220, 222. However, the first and second liner members 220, 222 can be connected by three or more connection members, four or more connection members, five or more connection members, six or more connection members, etc.

Referring to FIG. 3, the liner 202 can have a length L of between about 5 inches and about 100 inches, such as between about 5 inches and about 50 inches, such as between about 10 inches and about 45 inches, such as between about 20 inches and about 40 inches, such as between about 25 inches and about 35 inches, such as about 30 inches. In the illustrated example, the connection between the first and second liner members 220, 222 extends along the length L of the liner 202. A length L1 of the connection can be between about 1 inch and about 95 inches, such as between about 1 inch and about 75 inches, such as between about 1 inch and about 50 inches, such as between about 1 inch and about 25 inches, such as between about 1 inch and about 10 inches, such as between about 4 inches and about 8 inches, such as about 6 inches. A ratio of the length L of the liner 202 to the length L1 of the connection can be between about 1 to 1 and about 100 to 1, such as between about 1 to 1 and about 75 to 1, such as between about 1 to 1 and about 50 to 1, such as between about 1 to 1 and about 25 to 1, such as between about 1 to 1 and about 10 to 1, such as between about 3 to 1 and about 7 to 1, such as about 5 to 1. While the illustrated example shows the connection by a connector 232, it should be understood that the connection extending the length L1 can be a direct connection between the first and second liner members 220, 222. Referring to FIG. 4, the liner 202 can have a height H of between about 1 inch and about 20 inches, such as between about 1 inch and about 10 inches, such as between about 3 inches and about 8 inches, such as between about 6 inches and about 7 inches, such as about 6.7 inches.

Referring again to FIG. 3, the illustrated example shows a connector 232 disposed at a single location along the length of the liner (i.e., proximate a center of the liner 202 along the length L). Other examples may include a single connector 232 positioned at a location other than the center of the liner 202. Other examples can have two or more connecters 232 positioned at various locations along the length L of the liner. In these examples, each of the connectors 232 can extend any length described for length L1. In some instances, one or more straps with connectors (e.g., buttons, hook and loop connectors, etc.) can be positioned at various locations along the length of the liner 202. In these instances, the straps may extend a length L1 along the length L of the liner 202, or the straps may be positioned at one or more points along the length L of the liner 202, rather than extending the length L1.

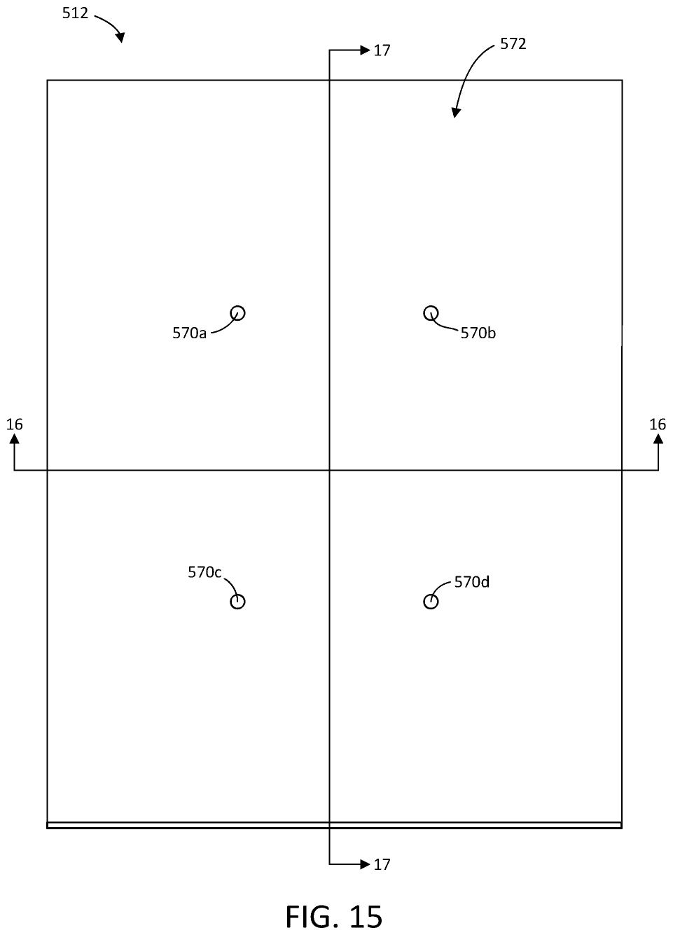

Still referring to FIG. 3, in various examples, the position of the connections between the first and second liner members 220, 222 (e.g., via connector(s) 232 or direct connection) allow for openings 231a, 231b to be disposed between the first and second liner members 220, 222. These openings 231a, 231b allow for portions of the pet bed to be disposed between the first and second liner members 220, 222. For example, a portion of a cover of the pet bed can extend through the openings 231a, 231b when the cover extends over the liner 202, such as, any of the tuft strips shown in FIGS. 15-20.

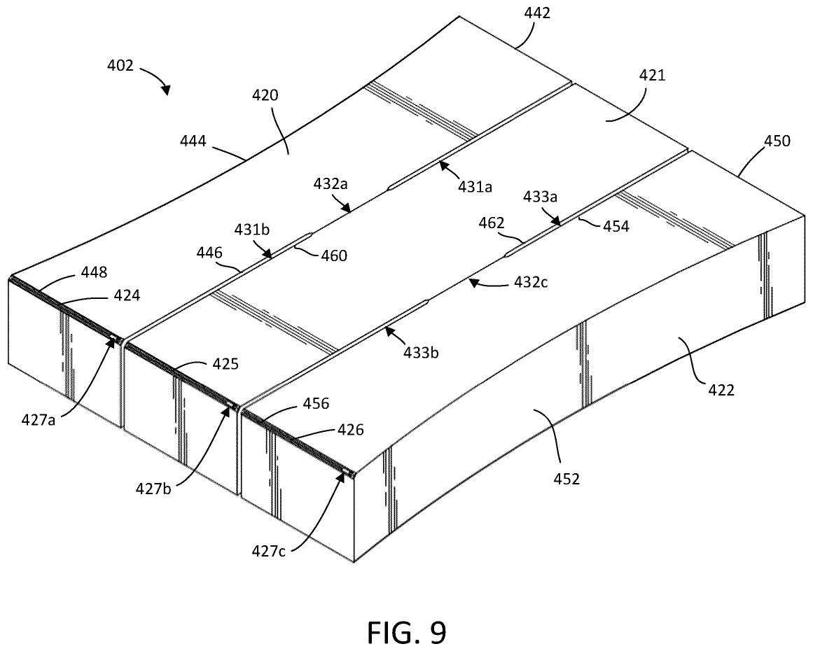

While the illustrated embodiment shows the liner 202 having two liner members 220, 222, it should be understood that the liner 202 can have any suitable number of liner members that are attached to adjacent liner members to form the liner 202. For example, the liner 202 can have three or more liner members (e.g., similar to the liner 402 shown in FIGS. 9-14), four or more liner members, five or more liner members, etc. In these instances, the liner members can be attached to adjacent liner members by any suitable means and at any suitable positions, such as, for example, any means and positions described in the present application.

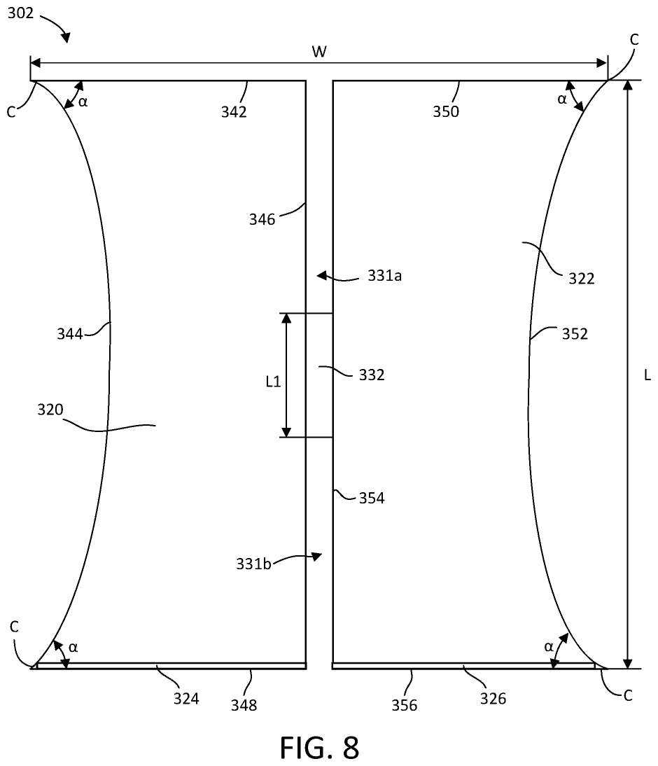

FIG. 8 illustrates an example of a liner 302 for a pet bed. The liner 302 includes a first liner member 320 and a second liner member 322 that is connected to the first liner member 320. The first and second liner members 320, 322 can be made of, for example, a non-woven material (e.g., polypropylene) or a woven material (e.g., taffeta). The pet bed can include a cover (not shown) that extends over the liner 302. The cover can take any suitable form, such as, for example, any form described in the present application.

The first liner member 320 has an opening 324 that allows a user to access an interior of the first liner member 320, where the opening 324 is movable between open and closed configurations. The second liner member 322 has an opening 326 that allows a user to access an interior of the second liner member 322, where the opening 326 is movable between open and closed configurations. The first and second liner members 320, 322 can each include a fastener (e.g., a zip fastener, button(s), etc.) that allows for a user to move the respective openings 324, 326 between the open and closed configurations. The openings 324, 326 allow for filling material (e.g., fiberfill, foam, etc.) to be placed into the interior of each of the first and second liner members 320, 322 such that the liner 302 provides cushioning for a pet that is using the pet bed, as well as allowing for a user to move or replace filling material that is disposed within each of the first and second liner members 320, 322.

The interiors of the first and second liner members 320, 322 are not in communication with each other. That is, interiors of the first and second liner members 320, 322 are separated from each other such that a user can only access the interior of the first liner member 320 via the opening 324, and such that the user can only access the interior of the second liner member 322 via the opening 326. This is advantageous because filling is prevented from moving from the first liner member 320 to the second liner member 322, and vice versa, when a pet is using the pet bed, which prevents the pet bed from becoming uneven due to more filling being disposed on one side of the pet bed versus the other side of the pet bed. That is, with typical pet beds, a pet may be situated on one side of the pet bed which causes the filling on that side of the pet bed to move to the other side of the pet bed such that the pet bed is uneven. In these situations, the pet bed may remain uneven when the pet is no longer using the pet bed. However, referring to the example liner 302 shown in FIG. 8, the two separate liner members 320, 322 having interiors that are not in communication with each other prevents filling from moving to the other side of the pet bed, which prevents the pet bed from becoming uneven.

The first liner member 320 has a top edge 342, an outer side edge 344, an inner side edge 346, and a bottom edge 348. The second liner member 322 has a top edge 350, an outer side edge 352, an inner side edge 354, and a bottom edge 356. The outer side edges 344, 352 of the first and second liner members 320, 322, respectively, are shaped such that a user can more easily place a cover (not shown) over the liner. The outer side edges 344, 352 are also shaped to ensure that filling material (e.g., fiberfill, foam, etc.) is disposed inside the liner 302 such that the corners C of the liner 302 extend fully to each corner of the cover (not shown), which allows pet bed to maintain a substantially uniform height along both the length L and width W of the liner 302 and cover. For example, the outer sides edges 344, 352 can have a shape in which the width W is variable along a length L of the liner 302. As shown in the illustrated example, the outer side edges 344, 352 can be trumpeted or curved. However, the outer side edges 344, 352 can take any other suitable form in which the width decreases from at least one of the top edges 342, 350 or bottom edges 348, 356 of the first and second liner members 320, 322 toward a central portion of the liner 302. In certain instances, an angle α at the outer corners C of the first and second liner members 320, 322 can be between about 15 degrees and about 89 degrees, such as between about 45 degrees and about 89 degrees, such as between about 60 degrees and about 89 degrees, such as between about 75 degrees and about 89 degrees, such as between about 80 degrees and 89 degrees, such as about 86 degrees. The angle α at the outer corners C can be identical at each of the outer corners, or the angles can be different at one or more of the corners. The liner 302 can take any suitable shape in which the width W of the liner 302 decreases at some portion along a length L of the liner 302, such as, for example, any shape described in the present application.

The first and second liner members 320, 322 can be connected in a variety of ways. For example, one or more connection members 332 can be connected to each of the liner members 320, 322. The connection member can include, for example, a piece of cloth, a strap and buttoned member, a hook and loop member, a zippered member, a snap-type member, and/or any other suitable component that is capable of connecting the first and second liner members 320, 322 to each other. In other examples, the first and second liner members can be directly connected to each other. The first liner member 320, the second liner member 322, and/or the connection member 332 can be connected by any suitable means, such as, for example, by sewing, an adhesive, a hook and loop connection, a buttoned connection, or any other suitable type of connection. The first and second liners 320, 322 can be fixedly connected (e.g., via sewing, adhesive, etc.) or removably connected (e.g., via a hook and loop connection, a buttoned connection, a zippered connection, a snap-type connection, etc.).

The first and second liner members 320, 322 can be connected in any suitable location, such as, for example, any of the locations shown in FIGS. 4-7 or any other location described in the present application. The first and second liner members 320, 322 can be connected at a single location or at two or more locations, either directly or by one or more connection members. The first and second liner members 320, 322 can be connected by one or more connection members, two or more connection members, three or more connection members, four or more connection members, five or more connection members, six or more connection members, etc.

The liner 302 can have a length L of between about 5 inches and about 100 inches, such as between about 5 inches and about 50 inches, such as between about 10 inches and about 45 inches, such as between about 20 inches and about 40 inches, such as between about 25 inches and about 35 inches, such as about 30 inches. In the illustrated example, the connection between the first and second liner members 320, 322 extends along the length L of the liner 302. A length L1 of the connection can be between about 1 inch and about 95 inches, such as between about 1 inch and about 75 inches, such as between about 1 inch and about 50 inches, such as between about 1 inch and about 25 inches, such as between about 1 inch and about 10 inches, such as between about 4 inches and about 8 inches, such as about 6 inches. A ratio of the length L of the liner 302 to the length L1 of the connection can be between about 1 to 1 and about 100 to 1, such as between about 1 to 1 and about 75 to 1, such as between about 1 to 1 and about 50 to 1, such as between about 1 to 1 and about 25 to 1, such as between about 1 to 1 and about 10 to 1, such as between about 3 to 1 and about 7 to 1, such as about 5 to 1. While the illustrated example shows the connection by a connector 332, it should be understood that the connection extending the length L1 can be a direct connection between the first and second liner members 320, 322. The liner 302 can have a height (not shown—similar to the height H shown for the liner 202 shown in FIG. 4) that is between about 1 inch and about 20 inches, such as between about 1 inch and about 10 inches, such as between about 3 inches and about 8 inches, such as between about 6 inches and about 7 inches, such as about 6.7 inches.

The illustrated example shows a connector 332 disposed at a single location along the length of the liner (i.e., proximate a center of the liner 302 along the length L). Other examples may include a single connector 332 positioned at a location other than the center of the liner 302. Other examples can have two or more connecters 332 positioned at various locations along the length L of the liner. In these examples, each of the connectors 332 can extend any length described for length L1. In some instances, one or more straps with connectors (e.g., buttons, hook and loop connectors, etc.) can be positioned at various locations along the length of the liner 302. In these instances, the straps may extend a length L1 along the length L of the liner 302, or the straps may be positioned at one or more points along the length L of the liner 302, rather than extending the length L1.

In various embodiments, the position of the connections between the first and second liner members 320, 322 (e.g., via connector(s) 332 or direct connection) allow for openings 331a, 331b to be disposed between the first and second liner members 320, 322. These openings 331a, 331b allow for portions of the pet bed to be disposed between the first and second liner members 320, 322. For example, a portion of a cover of the pet bed can extend through the openings 331a, 331b when the cover extends over the liner 302, such as, any of the tuft strips shown in FIGS. 15-20.

While the illustrated embodiment shows the liner 302 having two liner members 320, 322, it should be understood that the liner 302 can have any suitable number of liner members that are attached to adjacent liner members to form the liner 302. In these instances, the outer liner members have the shape of the outer edges 344, 352 of the first and second liner members 320, 322 described above. The liner 302 can have two or more liner members, three or more liner members (e.g., similar to the liner 402 shown in FIGS. 9-14), four or more liner members, five or more liner members, etc. In these instances, the liner members can be attached to adjacent liner members by any suitable means and at any suitable positions, such as, for example, any means and positions described in the present application.

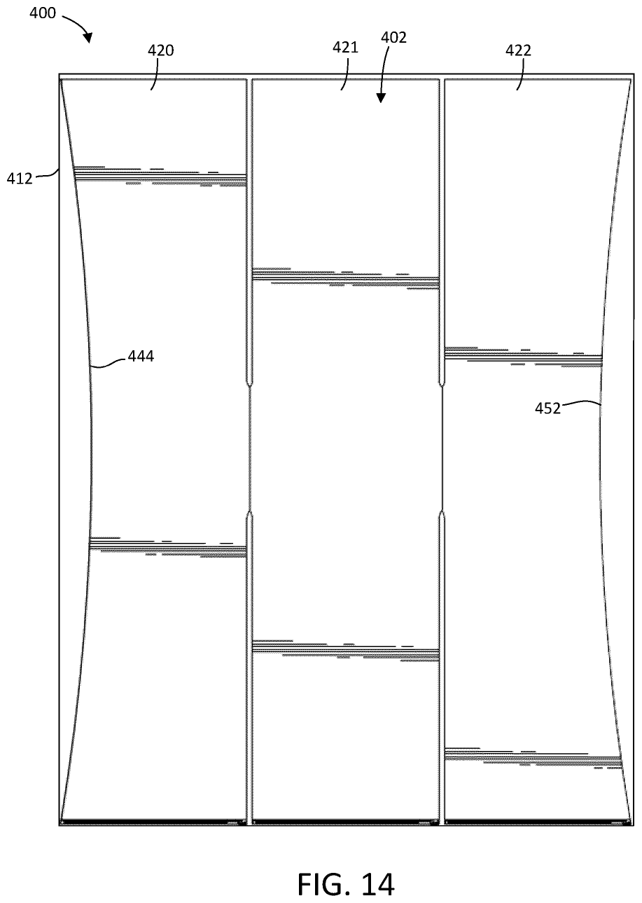

FIGS. 9-14 illustrate an example of a liner 402 for a pet bed 400 (FIG. 14). The liner 402 includes a first outer liner member 420, a second outer liner member 422, and a middle liner member 421 that is connected to both of the first and second outer liner members 420, 422. The liner members 420-422 can be made of, for example, a non-woven material (e.g., polypropylene) or a woven material (e.g., taffeta). The pet bed 400 can include a cover 412 (FIG. 14) that extends over the liner 402. The cover 412 can take any suitable form, such as, for example, any form described in the present application.

The first outer liner member 420 has an opening 424 that allows a user to access an interior of the first outer liner member 420, where the opening 424 is movable between open and closed configurations (shown in the closed configuration). The second outer liner member 422 has an opening 426 that allows a user to access an interior of the second outer liner member 422, where the opening 426 is movable between open and closed configurations (shown in the closed configuration). The middle liner member 421 has an opening 425 that allows a user to access an interior of the middle liner member 421, where the opening 425 is movable between open and closed configurations (shown in the closed configuration). Each of the liner members 420-422 include a fastener 427a-427c that allows for a user to move the corresponding openings 424-426 between the open and closed configurations. In the illustrated example, each of the fasteners 427a-427c include a zip fastener. However, the fasteners 427a-427c can take any suitable form, such as, for example, any form described in the present application. The openings 424-426 allow for filling material (e.g., fiberfill, foam, etc.) to be placed into the interior of each of the liner members 420-422 such that the liner 402 provides cushioning for a pet that is using the pet bed, as well as allowing for a user to move or replace filling that is disposed within each of the liner members 420-422.

The interiors of the liner members 420-422 are not in communication with each other. That is, interiors of the liner members 420-422 are separated from each other such that a user can only access the interior of the first outer liner member 420 via the opening 424, such that the user can only access the interior of the second outer liner member 422 via the opening 426, and such that the user can only access the interior of the middle liner member 421 via the opening 425. This is advantageous because filling is prevented from moving between the liner members 420-422, which prevents the pet bed 400 from becoming uneven due to more filling being disposed on one side of the pet bed versus the other side of the pet bed. That is, with typical pet beds, a pet may be situated on one side of the pet bed which causes the filling on that side of the pet bed to move to the other side of the pet bed such that the pet bed is uneven. In these situations, the pet bed may remain uneven when the pet is no longer using the pet bed. However, referring to the example liner 402 shown in FIG. 9-14, the three separate liner members 420-422 having interiors that are not in communication with each other prevents filling from moving to the other portions of the pet bed 400, which prevents the pet bed 400 from becoming uneven.

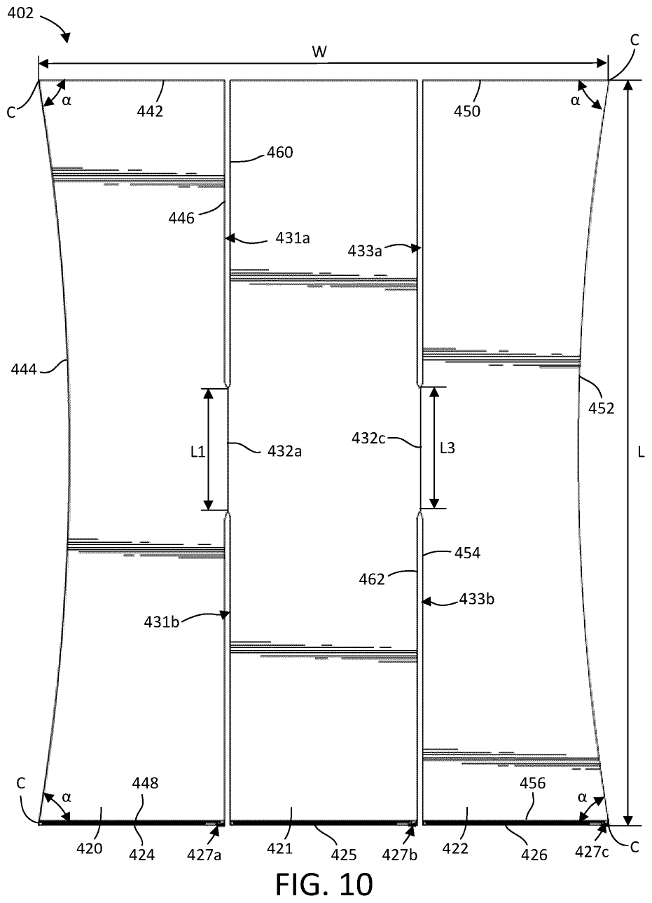

The first outer liner member 420 has a top edge 442, an outer side edge 444, an inner side edge 446, and a bottom edge 448. The second outer liner member 422 has a top edge 450, an outer side edge 452, an inner side edge 454, and a bottom edge 456. The outer side edges 444, 452 of the first and second outer liner members 420, 422, respectively, are shaped such that a user can more easily place the cover 412 (FIG. 14) over the liner 402. The outer side edges 444, 452 are also shaped to ensure that filling material (e.g., fiberfill, foam, etc.) is disposed inside the liner 402 such that the corners C of the liner 402 extend fully to each corner of the cover 412, which allows pet bed to maintain a substantially uniform height along both the length L and width W of the liner 402 and cover 412. For example, the outer side edges 444, 452 can have a shape in which the width W (FIG. 10) is variable along a length L (FIG. 10) of the liner 402. As shown in the illustrated example, the outer side edges 444, 452 can be trumpeted or curved. However, the outer side edges 444, 452 can take any other suitable form in which the width W of the liner 402 decreases toward a central portion of the liner 402. In certain instances, an angle α at the outer corners C (FIG. 10) of the first and second outer liner members 420, 422 can be between about 15 degrees and about 89 degrees, such as between about 45 degrees and about 89 degrees, such as between about 60 degrees and about 89 degrees, such as between about 75 degrees and about 89 degrees, such as between about 80 degrees and 89 degrees, such as about 86 degrees. The angle α at the outer corners C can be identical at each of the outer corners, or the angles can be different at one or more of the corners. The liner 402 can have a height H (FIG. 12) that is between about 1 inch and about 20 inches, such as between about 1 inch and about 10 inches, such as between about 3 inches and about 8 inches, such as between about 6 inches and about 7 inches, such as about 6.7 inches. The liner 402 can take any suitable shape in which the width W of the liner 402 decreases at some portion along a length L of the liner 402, such as, for example, any shape described in the present application.

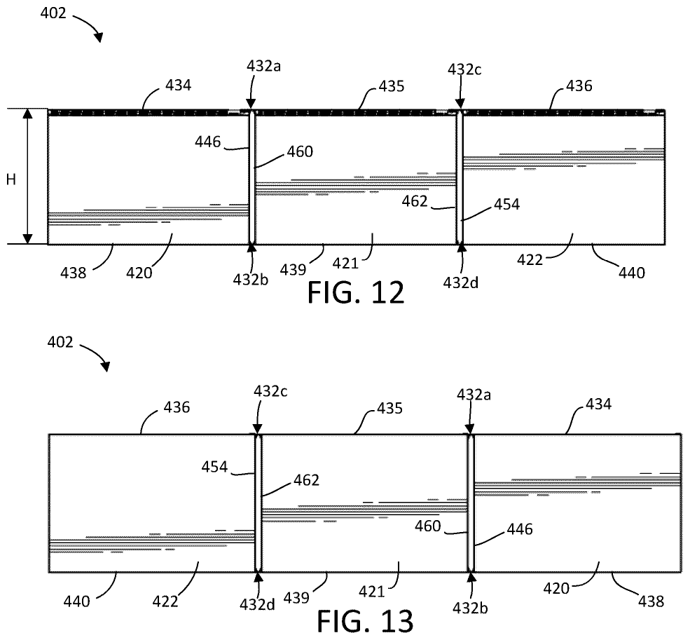

The first outer liner member 420 and the second outer liner member 422 can each be connected to the middle liner member 421. In the illustrated example, the inner side edge 446 of the first outer liner member 420 is connected to the side edge 460 of the middle liner member 421 at connection portions 432a, 432b and the inner side edge 454 of the second outer liner member 422 is connected to the side edge 462 of the middle liner member 421 at connection portions 432c, 432d. Referring to FIGS. 12 and 13, the connection portion 432a connects upper edge 434 of the first outer liner member 420 to the upper edge 435 of the middle liner member 421, and the connection portion 432c connects the upper edge 436 of the second outer liner member 422 to the upper edge 435 of the middle liner member 421. The connection portion 432b connects lower edge 438 of the first outer liner member 420 to the lower edge 439 of the middle liner member 421, and the connection portion 432d connects the lower edge 440 of the second outer liner member 422 to the lower edge 439 of the middle liner member 421. In the illustrated example, the connection portions 432a-d are direct connections (e.g., via sewing, adhesive, etc.) between the corresponding liner members 420-422. However, it should be understood that one or more connection members (e.g., any connection member described in the present application) can be used to create the connection portions 432a-d.

It should be understood, however, that the first and second outer liner members 420, 422 can be connected to the middle liner member 421 in a variety of ways and at a variety of locations. For example, the first and second outer liner members 420, 422 can be connected to the middle liner member 421 by any means and at any location described in the present application, such as the means and locations shown and described with reference to the connection between the liner members 220, 222 (e.g., the connections shown in FIGS. 4-7).

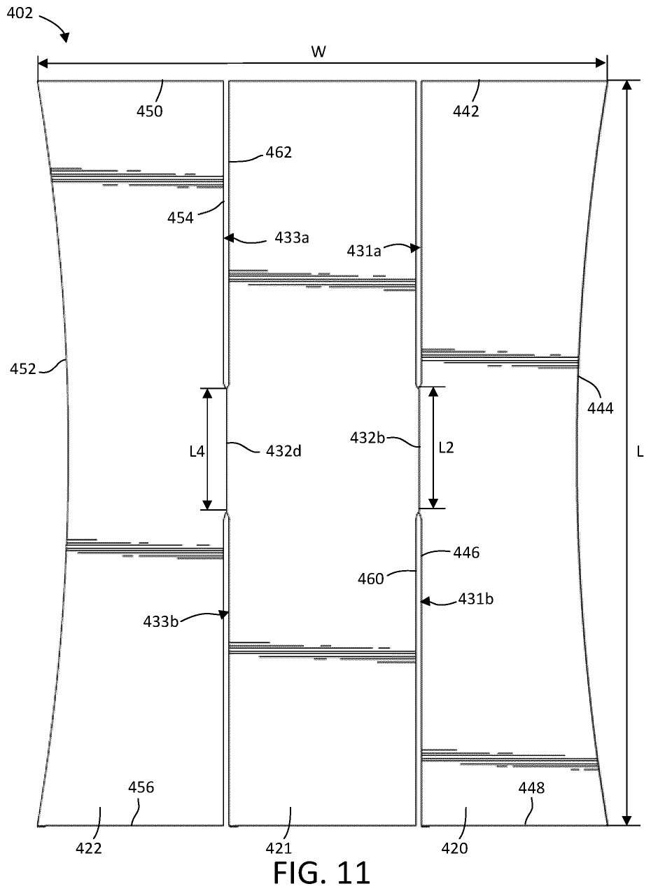

Referring to FIGS. 10 and 11, the connection portions 432a, 432b between the first outer liner member 420 and the middle liner member 421 extend along a length L of the liner 402. Each of the lengths L1-L4 of the connection portions 432a-432d can be between about 1 inch and about 95 inches, such as between about 1 inch and about 75 inches, such as between about 1 inch and about 50 inches, such as between about 1 inch and about 25 inches, such as between about 1 inch and about 10 inches, such as between about 4 inches and about 8 inches, such as about 6 inches. .A ratio of the length L to any one of the lengths L1-L4 can be between about 1 to 1 and about 100 to 1, such as between about 1 to 1 and about 75 to 1, such as between about 1 to 1 and about 50 to 1, such as between about 1 to 1 and about 25 to 1, such as between about 1 to 1 and about 10 to 1, such as between about 3 to 1 and about 7 to 1, such as about 5 to 1. While the illustrated example shows the connection portions 432a-432d being direct connections between the corresponding liner members, it should be understood that the connections can include a connection member(s) that extends the lengths L1-L4.

The position of the connection portions 432a-432d can allow for openings 431a, 431b to be disposed between the first outer liner member 420 and the middle liner member 421, as well as openings 433a, 433b between the second outer liner member 422 and the middle liner member 421. Portions of the pet bed to be disposed in these openings. For example, a portion of a cover of the pet bed can extend through the openings when the cover extends over the liner 402, such as, any of the tuft strips shown in FIGS. 15-20.

While the illustrated embodiment shows the liner 402 having three liner members 420-422, it should be understood that the liner 402 can have any suitable number of liner members that are attached to adjacent liner members to form the liner 402. In any of these instances, the outermost liner members have the shape of the outer edges 444, 452 of the first and second outer liner members 420, 422 described above. The liner 402 can have two or more liner members (similar to the liners 202 and 302 described in the present application), three or more liner members, four or more liner members, five or more liner members, etc. In these instances, the liner members can be attached to adjacent liner members by any suitable means and at any suitable positions, such as, for example, any means and positions described in the present application.

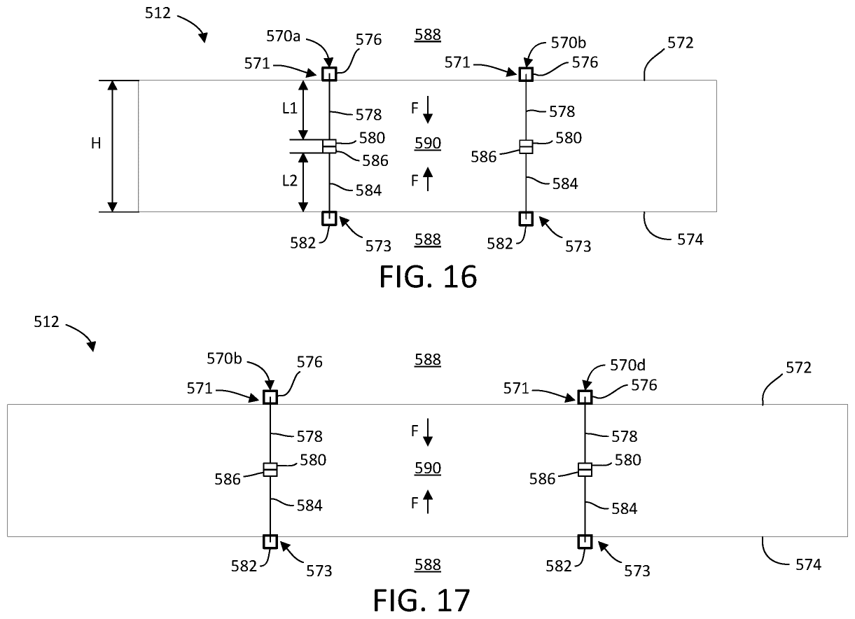

FIGS. 15-17 illustrate a cover 512 for a pet bed, where the cover 512 includes a plurality of tuft strips 570a-570d. The tuft strips 570a-570d connect a top portion 572 of the cover 512 to a bottom portion 574 of the cover 512. The tuft strips 570a-570d are configured to connect the top portion 572 to the bottom portion 574 on a gusseted pet bed without distorting the shape of the pet bed. That is, the tuft strips 570a-570d provide support to the pet bed such that the pet bed can have a gusset with a larger height. In various examples, referring to FIG. 16, the pet bed can have a height H of between about 1 inch and about 20 inches, such as between about 1 inch and about 10 inches, such as between about 3 inches and about 8 inches, such as between about 6 inches and about 7 inches, such as about 6.7 inches.

Referring to FIGS. 16 and 17, each of the tuft strips 570a-570d include an upper tuft strip member 571 and a lower tuft strip member 573 that is releasably connected to the upper tuft strip member 571 such that the tuft strips 570a-570d are movable between connected and disconnected configurations. The upper tuft strip member 571 can be attached to the top portion 572 of the cover 512 and include an optional upper exterior member 576, an upper extension member 578, and an upper connection member 580. The lower tuft strip member 573 can be attached to a bottom portion 574 of the cover 512 and include an optional lower exterior member 582, a lower extension member 584, and a lower connection member 586.

The upper exterior member 576 can be positioned on an exterior of the top portion 572 of the cover 512 and connected to the upper extension member 578. The upper exterior member 576 can be directly connected to the upper extension member 578 or connected to the upper extension member 578 via a connection with the top portion 572 of the cover. The upper exterior member 576 can be sized to maintain a position on an exterior 588 of the cover 512 as other portions of the tuft strips 570a-570d are positioned in an interior 590 of the cover 512. The upper exterior member 576 can be, for example, a button, a sewn tuft, a sewn seam, etc.

The upper extension member 578 can be attached to the upper exterior member 576 and extend through an opening (not shown) in the cover 512 such that the upper extension member 578 extends into the interior 590 of the cover 512. In other examples, the upper extension member 578 does not extend through an opening of the cover 512 but is connected to the top portion 572 of the cover on an interior side of the cover 512. The upper extension member 578 can be attached to the upper exterior member 576 or the interior side of the cover 512 by, for example, an adhesive, a sewing connection, or any other suitable means. The upper extension member 578 can be, for example, a strap, a fabric strip, a hook and loop connection, an elastic connection, or any other suitable member. The upper extension member 578 can be made of, for example, a woven or non-woven material (e.g., polyester, cotton, etc.) or any other suitable material. The upper extension members 578 can be configured to extend a length L1 from the top portion 572 of the cover 512, where the length L1 (FIG. 16) is between about 1 inch and about 20 inches. While the length L1 is only shown for the tuft strip 570a, it should be understood that the length L1 can also be the length that the upper extension members 578 of the other tuft strips 570b-570d extend from the top portion 572 of the cover 512.

The upper connection member 580 can be fixedly connected to the upper extension member 578 and configured to be releasably connected to the lower tuft strip member 573. The upper connection member 580 can be, for example, a male connector (e.g., a button, a pin, a snap member, etc.), a female connector (e.g., a snap member, a receptacle, an opening, etc.), a hook and loop connector, or any other component that is capable of releasably connecting to the lower tuft strip member 573. The upper connection member 580 can be fixedly connected to the upper extension member 578 by a sewn connection, an adhesive, or by any other suitable means. In some examples, the upper connection member 580 can be integral to the upper extension member 578. For example, the upper connection member 580 can be an opening in the upper extension member 578 that is configured to receive the lower connection member 586 of the lower tuft strip member 573.

The lower exterior member 582 can be positioned on an exterior of the bottom portion 574 of the cover 512 and connected to the lower extension member 584. The lower exterior member 582 can be sized to maintain a position on an exterior 588 of the cover 512 as other portions of the tuft strips 570a-570d extend into an interior 590 of the cover 512. The lower exterior member 582 can be, for example, a button, a sewn tuft, a sewn seam, etc.

The lower extension member 584 can be attached to the lower exterior member 582 and extend through an opening (not shown) in the cover 512 such that the lower extension member 584 extends into the interior 590 of the cover 512. In other examples, the lower extension member 584 does not extend through an opening of the cover 512 but is connected to the bottom portion 574 of the cover on an interior side of the cover 512. The lower extension member 584 can be attached to the lower exterior member 582 or the interior side of the cover 512 by, for example, an adhesive, a sewing connection, or any other suitable means. The lower extension member 584 can be, for example, a strap, a fabric strip, a hook and loop connection, an elastic connection, or any other suitable member. The lower extension member 584 can be made of, for example, a woven or non-woven material (e.g., polyester, cotton, etc.) or any other suitable material. The lower extension members 584 can be configured to extend a length L2 (FIG. 16) from the bottom portion 574 of the cover 512, where the length L2 is between about 1 inch and about 20 inches. While the length L2 is only shown for the tuft strip 570a, it should be understood that the length L2 can also be the length that the lower extension members 584 of the other tuft strips 570b-570d extend from the bottom portion 574 of the cover 512.

The lower connection member 586 can be fixedly connected to the lower extension member 584 and configured to be releasably connected to the upper tuft strip member 571. The lower connection member 586 can be, for example, a male connector (e.g., a button, a pin, a snap member, etc.), a female connector (e.g., a snap member, a receptacle, an opening, etc.), a hook and loop connector, or any other component that is capable of releasably connecting to the upper tuft strip member 571. The lower connection member 586 can be fixedly connected to the lower extension member 584 by a sewn connection, an adhesive, or by any other suitable means. In some examples, the lower connection member 586 can be integral to the lower extension member 584. For example, the lower connection member 586 can be an opening in the lower extension member 584 that is configured to receive the upper connection member 580 of the upper tuft strip member 571.

While tuft strip 570c is not shown in FIG. 16 or 17, it should be understood that tuft strip 570c can have a similar form to the tuft strips 570a, 570b, 570d shown in FIGS. 16 and 17. When the upper and lower tuft strip members 570a-570d are connected, the tuft strips 570a-570d provide an inward force F on the cover 512 at the locations of each of the tuft strips 570a-570d. This force F causes the pet bed to maintain its structured shape (e.g., a rectangular profile) and maintains a position of a liner within the cover 512.

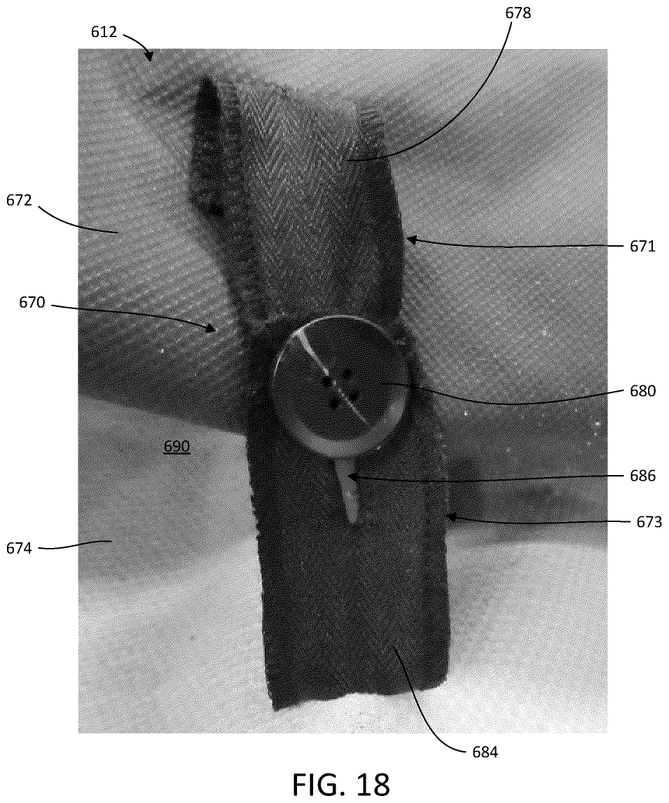

Referring to FIG. 18, an example tuft strip 670 for a cover 612 of a pet bed includes an upper tuft strip member 671 and a lower tuft strip member 673 that is releasably connected to the upper tuft strip member 671 such that the tuft strip 670 is movable between connected and disconnected configurations. The upper tuft strip member 671 can be attached to the top portion 672 of the cover 612 and include an optional upper exterior member (not shown), an upper extension member 678, and an upper connection member 680. The lower tuft strip member 673 can be attached to a bottom portion 674 of the cover 612 and include an optional lower exterior member (not shown), a lower extension member 684, and a lower connection member 686. The upper and lower exterior members can take any suitable form, such as, for example, any form described in the present application with reference to FIGS. 15-17.

In the illustrated example, the upper extension member 678 is attached to an interior side of the top portion 672 of the cover 612. In other examples, the upper extension member 678 is connected to the upper exterior member and extends through an opening (not shown) in the cover 612 such that the upper extension member 678 extends into the interior 690 of the cover 612. The upper extension member 678 can be attached to the upper exterior member or the interior side of the cover 612 by, for example, an adhesive, a sewing connection, or any other suitable means. In the illustrated example, the upper extension member 678 is a strap. The upper extension member 678 can be made of, for example, a fabric strip, a hook and loop connection, an elastic connection, or any other suitable member. The upper extension members 678 can be configured to extend a length (e.g., similar to the length L1 shown in FIG. 16) of between about 1 inch and about 20 inches from the top portion 672 of the cover 612 and into the interior 690 of the cover 612.

The upper connection member 680 can fixedly connected to the upper extension member 678 and configured to be releasably connected to the lower tuft strip member 673. In the illustrated example, the upper connection member 680 includes a button that is sewn to the upper extension member 678.

In the illustrated example, the lower extension member 684 is attached to an interior side of the bottom portion 674 of the cover 612. In other examples, the lower extension member 684 is connected to the lower exterior member and extends through an opening (not shown) in the cover 612 such that the lower extension member 684 extends into the interior 690 of the cover 612. The lower extension member 684 can be attached to the lower exterior member (not shown) or the interior side of the cover 612 by, for example, an adhesive, a sewing connection, or any other suitable means. In the illustrated example, the lower extension member 684 is a strap. The lower extension members 684 can be configured to extend a length (e.g., similar to the length L2 shown in FIG. 16) of between about 1 inch and about 20 inches from the bottom portion 674 of the cover 612 and into the interior 690 of the cover 612.

The lower connection member 686 can be fixedly connected to the lower extension member 684 and configured to be releasably connected to the upper tuft strip member 671. In the illustrated example, the lower connection member 686 includes an opening that is integral to the lower extension member 684 and configured to receive the upper connection member 680 to secure the upper and lower tuft strips 671, 673 together.

While the upper connection member 680 is shown as being a button and the lower connection member 686 is shown as being an opening that is integral to the lower extension member 684, it should be understood that, in other examples, the lower connection member 686 can be a button and the upper connection member 680 can be an opening that is integral to the upper extension member 678. In other examples, the upper or lower connection member can include an opening on a component that is attached to the upper or lower extension member, respectively.

The tuft strip 670 can be used with any suitable cover for a pet bed. For example, the tuft strip 670 can be used for the tuft strips 570a-570d for the cover 512 shown in FIGS. 15-17.

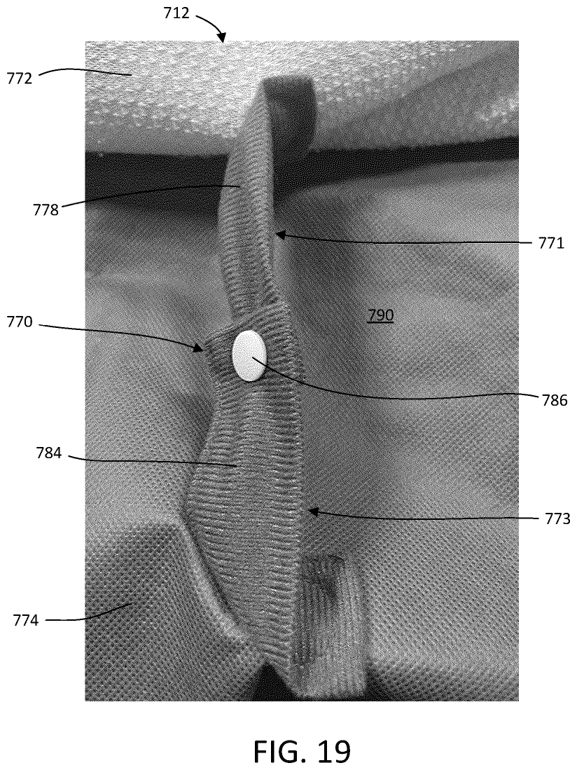

Referring to FIG. 19, an example tuft strip 770 for a cover 712 of a pet bed includes an upper tuft strip member 771 and a lower tuft strip member 773 that is releasably connected to the upper tuft strip member 771 such that the tuft strip 770 is movable between connected and disconnected configurations. The upper tuft strip member 771 can be attached to the top portion 772 of the cover 712 and include an optional upper exterior member (not shown), an upper extension member 778, and an upper connection member (not shown). The lower tuft strip member 773 can be attached to a bottom portion 774 of the cover 712 and include an optional lower exterior member (not shown), a lower extension member 784, and a lower connection member 786. The upper and lower exterior members can take any suitable form, such as, for example, any form described in the present application with reference to FIGS. 15-17.

In the illustrated example, the upper extension member 778 is attached to an interior side of the top portion 772 of the cover 712. In other examples, the upper extension member 778 is connected to the upper exterior member and extends through an opening (not shown) in the cover 712 such that the upper extension member 778 extends into the interior 790 of the cover 712. The upper extension member 778 can be attached to the upper exterior member (not shown) or the interior side of the cover 712 by, for example, an adhesive, a sewing connection, or any other suitable means. In the illustrated example, the upper extension member 778 is a strap. The upper extension member 778 can be made of, for example, a fabric strip, a hook and loop connection, an elastic connection, or any other suitable member. The upper extension members 778 can be configured to extend a length (e.g., similar to the length L1 shown in FIG. 16) of between about 1 inch and about 20 inches from the top portion 772 of the cover 712 and into the interior 790 of the cover 712.

The upper connection member (not shown) can be fixedly connected to the upper extension member 778 and configured to be releasably connected to the lower tuft strip member 773. In the illustrated example, the upper connection member includes a male or female connector that is configured to attach to the lower connection member 786 of the lower tuft strip member 773.

In the illustrated example, the lower extension member 784 is attached to an interior side of the bottom portion 774 of the cover 712. In other examples, the lower extension member 784 is connected to the lower exterior member and extends through an opening (not shown) in the cover 712 such that the lower extension member 784 extends into the interior 790 of the cover 712. The lower extension member 784 can be attached to the lower exterior member (not shown) or the interior side of the cover 712 by, for example, an adhesive, a sewing connection, or any other suitable means. In the illustrated example, the lower extension member 784 is a strap. The lower extension members 784 can be configured to extend a length (e.g., similar to the length L2 shown in FIG. 16) of between about 1 inch and about 20 inches from the bottom portion 774 of the cover 712 and into the interior 790 of the cover 712.

The lower connection member 786 can fixedly connected to the lower extension member 784 and configured to be releasably connected to the upper tuft strip member 771. In the illustrated example, the lower connection member 786 includes a male or female connector that is configured to connect to the male or female connector of the upper connection member (not shown).

The tuft strip 770 can be used with any suitable cover for a pet bed. For example, the tuft strip 770 can be used for the tuft strips 570a-570d for the cover 512 shown in FIGS. 15-17.

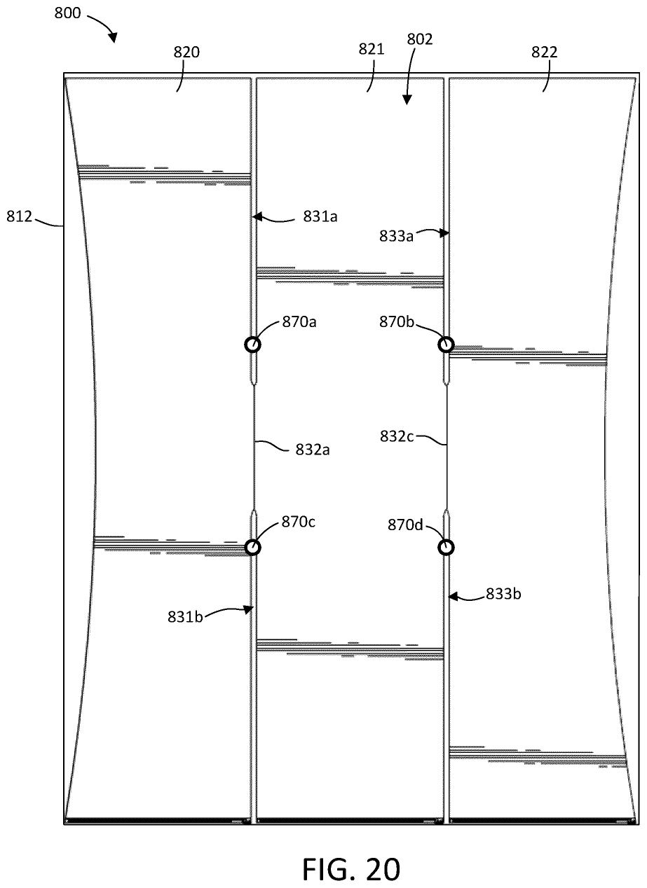

Referring to FIG. 20, an example of a pet bed 800 includes a liner 802 and a cover 812. In the illustrated example, the liner 802 takes the form of the liner 402 shown in FIGS. 9-14, and the cover 812 takes the form of the cover 512 shown in FIGS. 15-17. The cover 812 can include tuft strips 870a-870d, which can take any suitable form, such as, for example, any form described in the present application. In the illustrated example, the liner 802 includes a first outer liner member 820, a second outer liner member 822, and a middle liner member 821 that is connected to both of the first and second outer liner members 820, 822. The liner members 820-822 can take any suitable form, such as, for example, any form described in the present application. In the illustrated example, the first and second outer liner members 820, 822 can be connected to the middle liner 821 at connection portions 832a, 832c, respectively. As a result of these connections, the liner 802 has openings 831a, 831b between the first outer liner member 820 and the middle liner member 821, and the liner 802 has openings 833a, 833b between the second outer liner member 822 and the middle liner member 821. The tuft strips 870a-870d are positioned on the cover 812 such that the tuft strips 870a-870d are positioned in a corresponding opening when the liner is positioned within the cover.

The tuft strips 870a-870d are movable between connected and disconnected configurations such that a user can insert and remove the liner 802 from the cover 812. That is, when the liner 802 is being inserted into the cover 812, the tuft strips 870a-870d can be in a disconnected configuration such that the tuft strips 870a-870d do not prevent movement of the liner 802. Once the liner 802 is positioned within the cover 812 such that the tuft strips 870a-870d are in a corresponding opening 831a-831b, 833a-833b, the tuft strips can be moved to a connected configuration. When a user wants to remove the liner 802 from the cover 812, the tuft strips 870a-870d can be moved to the disconnected configuration such that the tuft strips 870a-870d do not prevent movement of the liner 802 out of the cover 812. The tuft strips 870a-870d can be moved between connected and disconnected configurations by any suitable means, such as, for example, any means described in the present application.

While various inventive aspects, concepts and features of the inventions may be described and illustrated herein as embodied in combination with exemplary embodiments, these various aspects, concepts and features may be used in many alternative embodiments, either individually or in various combinations and sub-combinations thereof. Unless expressly excluded herein, all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein.

Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

1. A liner for a pet bed, comprising:
a first liner member having a first opening and a first interior area, wherein the first opening is movable between open and closed configurations; and
a second liner member having a second opening and a second interior area, wherein the second opening is movable between open and closed configurations;
wherein the second liner member is connected to the first liner member such that the first and second interior areas are not in communication with each other.

2. The liner according to claim 1, wherein each of the first and second liner members have an inner edge where the first and second liner members are connected and a curved exterior edge that is opposite the inner edge.

3. The liner according to claim 1, further comprising a third liner member having a third opening and a third interior area, wherein the third opening is movable between open and closed configurations, and wherein the third liner member is connected to the first liner member on a side opposite the connection between the first liner member and the second liner member such that the first and third interior areas are not in communication with each other.

4. The liner according to claim 3, wherein each of the second and third liner members have an inner edge that is connected to the first liner member and a curved exterior edge that is opposite the inner edge.

5. The liner according to claim 1, wherein an upper edge of the first liner member is connected to an upper edge of the second liner member.

6. The liner according to claim 1, wherein a lower edge of the first liner member is connected to a lower edge of the second liner member.

7. The liner according to claim 1, wherein the first and second liner members are attached to each other at a position between the upper and lower edges of each of the first and second liner members.

8. The liner according to claim 1, wherein the first and second liner members are directly connected.

9. The liner according to claim 8, wherein the first and second liner members are connected by a sewing connection.

10. The liner according to claim 1, further comprising one or more connection members that connect the first and second liner members together.

11. A cover for a pet bed, comprising:
a top cover portion;
a bottom cover portion; and
one or more tuft strips connected to the top and bottom cover portions, each of the tuft strips comprising:
an upper tuft strip member having an upper extension member and an upper connection member; and
a lower tuft strip member having a lower extension member and a lower connection member;
wherein the upper connection member and lower connection member are configured to be releasably connected in an interior of the cover such that the tuft strip is movable between a connected configuration and a disconnected configuration.

12. The cover according to claim 11, wherein upper connection member and the lower connection member are configured to be releasably connected by a buttoned connection.

13. The cover according to claim 12, wherein the upper connection member comprises a button and the lower connection member comprises an opening for receiving the button.

14. The cover according to claim 11, wherein the upper connection member comprises a female connector and the lower connection member comprises a male connector.

15. The cover according to claim 11, wherein the one or more tuft strips comprise four tuft strips.

16. The cover according to claim 11, wherein the upper tuft strip comprises an exterior member that is positioned on an exterior of the cover.

17. The cover according to claim 11, wherein each of the upper and lower extension members comprise straps.

18. A pet bed, comprising:
a cover having a top portion and a bottom portion that at least partially define a bed interior, the cover further comprising a plurality of tuft strips, wherein each tuft strip comprises an upper tuft strip member that is connected to the top portion of the cover and a lower tuft strip member that is connected to the bottom portion of the cover, and wherein the upper tuft strip member and lower tuft strip member are configured to be releasably connected such that tuft strip is movable between a connected configuration and a disconnected configuration;
a liner configured to be disposed in the bed interior of the cover, the liner comprising:
a first outer liner member having a first opening and a first interior area, wherein the first opening is movable between open and closed configurations; and
a second outer liner member having a second opening and a second interior area, wherein the second opening is movable between open and closed configurations;
a middle liner member having a third opening and a third interior area, wherein the third opening is movable between open and closed configurations;
wherein the first outer liner member is connected to the middle liner member such that one or more first elongated openings are disposed between the first outer liner member and the middle liner member;
wherein the second outer liner member is connected to the middle liner member such that one or more second elongated openings are disposed between the second outer liner member and the middle liner member;
wherein at least one first tuft strip of the plurality of tuft strips of the cover is positioned in at least one first elongated opening of the one or more first elongated openings when the at least one first tuft strip is in a connected configuration;
wherein at least one second tuft strip of the plurality of tuft strips of the cover is positioned in at least one second elongated opening of the one or more second elongated openings when the at least one second tuft strip is in a connected configuration.

19. The pet bed according to claim 18, wherein each of the first and second outer liner members have an inner edge that is connected to the middle liner member and a curved exterior edge that is opposite the inner edge.

20. The pet bed according to claim 18, wherein the first outer liner member is connected to the middle liner member such that the first and third interior areas are not in communication with each other, and wherein the second outer liner member is connected to the middle liner member such that the second and third interior areas are not in communication with each other.

21. The pet bed according to claim 18, wherein the first outer liner member is directly connected to the middle liner member by a sewing connection, and wherein the second outer liner member is directly connected to the middle liner member by a sewing connection.

22. The pet bed according to claim 18, wherein the first outer liner member is connected to the middle liner member by a one or more first connection members, and wherein the second outer liner member is connected to the middle liner member by one or more second connection members.

23. The pet bed according to claim 18, wherein upper tuft strip member and the lower tuft strip member are configured to be releasably connected by a buttoned connection.

24. The pet bed according to claim 23, wherein the upper tuft strip member comprises a button and the lower tuft strip member comprises an opening for receiving the button.

25. The pet bed according to claim 18, wherein the upper tuft member comprises a female connector and the lower tuft strip member comprises a male connector.

26. The cover according to claim 18, wherein the plurality of tuft strips comprises four tuft strips.

27. The cover according to claim 18, wherein each of the upper and lower tuft strip members comprise straps.
